(19) United States
(12) Patent Application Publication
(10) Pub. No.: US 2025/0063022 A1
(43) Pub. Date: Feb. 20, 2025

(54) REVERSE PROXY INSPECTION FOR ENCRYPTED TRAFFIC IN AN EDGE-BASED NETWORK

(71) Applicant: International Business Machines Corporation, Armonk, NY (US)

(72) Inventors: Sandeep Sukhija, Rajasthan (IN); Rajesh Kumar Saxena, Thane West (IN); Harish Bharti, Pune (IN); Ankit Singhal, Meerut (IN)

(21) Appl. No.: 18/451,000

(22) Filed: Aug. 16, 2023

(51) Int. Cl. H04L 9/40

(52) U.S. Cl. CPC H04L 63/0281; H04L 63/0428; H04L 63/0823

(57) ABSTRACT

One embodiment of the invention provides a method for reverse proxy inspection (RPI) of encrypted traffic in an edge-based network. The method comprises sharing a first certificate from an RPI instance to an edge-based network gateway. The first certificate is issued to the RPI instance. The method further comprises receiving, at the RPI instance, an encrypted message with an initial layer of encryption and a subsequent layer of encryption. The initial layer is encrypted using a second certificate issued to an edge-based network device. The subsequent layer is encrypted using the first certificate. The method further comprises, at the RPI instance, authenticating the first certificate, and decrypting the subsequent layer using the first certificate, resulting in the encrypted message with the initial layer intact. The method further comprises, at the RPI instance, inspecting the encrypted message, and forwarding the encrypted message to a centralized hub.

### BACKGROUND

The field of embodiments of the invention generally relate to edge-based networks.

An edge-based network is a network located at the edge of a centralized network that brings data storage and computation as near the required point as possible, pushing applications, data, and computing power away from the centralized data center in order to deliver low latency and save bandwidth.

### SUMMARY

Embodiments of the invention generally relate to edge-based networks, and more specifically, reverse proxy inspection (RPI) of encrypted traffic in an edge-based network.

One embodiment of the invention provides a computer-implemented method for RPI of encrypted traffic in an edge-based network. The method comprises sharing a first certificate from an RPI instance of the network to an edge-based network gateway of the network. The first certificate is issued to the RPI instance. The method further comprises receiving, at the RPI instance, an encrypted message with an initial layer of encryption and a subsequent layer of encryption. The initial layer of encryption is encrypted using a second certificate issued to an edge-based network device of the network. The subsequent layer of encryption is encrypted using the first certificate. The method further comprises authenticating, at the RPI instance, the first certificate. The method further comprises decrypting, at the RPI instance, the subsequent layer of encryption using the first certificate, resulting in the encrypted message with the initial layer of encryption intact. The method further comprises inspecting, at the RPI instance, the encrypted message, and forwarding the encrypted message from the RPI instance to a centralized hub of the network. Other embodiments include a system for RPI of encrypted traffic in an edge-based network, and a computer program product for RPI of encrypted traffic in an edge-based network.

### BRIEF DESCRIPTION OF THE DRAWINGS

The subject matter which is regarded as embodiments of the invention are particularly pointed out and distinctly claimed in the claims at the conclusion of the specification. The foregoing and other objects, features, and advantages of embodiments of the invention are apparent from the following detailed description taken in conjunction with the accompanying drawings in which:

FIG. 1 depicts a computing environment according to an embodiment of the present invention;

FIG. 2 illustrates an example edge-based network implementing reverse proxy inspection (RPI), in accordance with an embodiment of the invention;

FIG. 3 illustrates an example workflow for implementing RPI in the edge-based network, in accordance with an embodiment of the invention;

FIG. 4 illustrates an example workflow implemented by the RPI spawning framework, in accordance with an embodiment of the invention; and

FIG. 5 is a flowchart for an example process for RPI of encrypted traffic in an edge-based network, in accordance with an embodiment of the invention.

The detailed description explains the preferred embodiments of the invention, together with advantages and features, by way of example with reference to the drawings.

### DETAILED DESCRIPTION

Embodiments of the invention generally relate to edge-based networks, and more specifically, reverse proxy inspection (RPI) of encrypted traffic in an edge-based network. One embodiment of the invention provides a computer-implemented method for RPI of encrypted traffic in an edge-based network. The method comprises sharing a first certificate from an RPI instance of the network to an edge-based network gateway of the network. The first certificate is issued to the RPI instance. The method further comprises receiving, at the RPI instance, an encrypted message with an initial layer of encryption and a subsequent layer of encryption. The initial layer of encryption is encrypted using a second certificate issued to an edge-based network device of the network. The subsequent layer of encryption is encrypted using the first certificate. The method further comprises authenticating, at the RPI instance, the first certificate. The method further comprises decrypting, at the RPI instance, the subsequent layer of encryption using the first certificate, resulting in the encrypted message with the initial layer of encryption intact. The method further comprises inspecting, at the RPI instance, the encrypted message, and forwarding the encrypted message from the RPI instance to a centralized hub of the network.

Another embodiment of the invention provides a system for RPI of encrypted traffic in an edge-based network. The system comprises at least one processor and a processor-readable memory device storing instructions that when executed by the at least one processor causes the at least one processor to perform operations. The operations include sharing a first certificate from an RPI instance of the network to an edge-based network gateway of the network. The first certificate is issued to the RPI instance. The operations further include receiving, at the RPI instance, an encrypted message with an initial layer of encryption and a subsequent layer of encryption. The initial layer of encryption is encrypted using a second certificate issued to an edge-based network device of the network. The subsequent layer of encryption is encrypted using the first certificate. The operations further include authenticating, at the RPI instance, the first certificate. The operations further include decrypting, at the RPI instance, the subsequent layer of encryption using the first certificate, resulting in the encrypted message with the initial layer of encryption intact. The operations further include inspecting, at the RPI instance, the encrypted message, and forwarding the encrypted message from the RPI instance to a centralized hub of the network.

One embodiment of the invention provides a computer program product for RPI of encrypted traffic in an edge-based network. The computer program product comprises a computer readable storage medium having program instructions embodied therewith. The program instructions are executable by a processor to cause the processor to share a first certificate from an RPI instance of the network to an edge-based network gateway of the network. The first certificate is issued to the RPI instance. The program instructions are executable by the processor to further cause the processor to receive, at the RPI instance, an encrypted message with an initial layer of encryption and a subsequent layer of encryption. The initial layer of encryption is encrypted using a second certificate issued to an edge-based network device of the network. The subsequent layer of encryption is encrypted using the first certificate. The program instructions are executable by the processor to further cause the processor to authenticate, at the RPI instance, the first certificate. The program instructions are executable by the processor to further cause the processor to decrypt, at the RPI instance, the subsequent layer of encryption using the first certificate, resulting in the encrypted message with the initial layer of encryption intact. The program instructions are executable by the processor to further cause the processor to inspect, at the RPI instance, the encrypted message, and forward the encrypted message from the RPI instance to a centralized hub of the network.

In at least some embodiments, the first certificate and the second certificate are different signed certificates issued by a Certificate Authority (CA).

In at least some embodiments, the first certificate is part of a first certificate chain used for end-to-end communication between the edge-based network gateway and the RPI instance, and the second certificate is part of a second certificate chain that is different from the first certificate chain and used for end-to-end communication between the edge-based network device and the centralized hub.

In at least some embodiments, the initial layer of encryption is encrypted at the edge-based network device, and the subsequent layer of encryption is encrypted at the edge-based network gateway.

In at least some embodiments, operational data relating to the network is monitored. The operational data comprises measurements of characteristics of the network, and the operational data is captured via Internet of Things (IoT) sensors coupled to or integrated in edge-based network devices of the network.

In at least some embodiments, a semantic graph of the network is derived from the operational data. The semantic graph is a knowledge graph representing a physical structure of the network and a data and event processing structure of the network. In at least some embodiments, an identity semantic network (ISN) is generated based on the semantic graph. The ISN represents causal relationships between the edge-based network devices. In at least some embodiments, the ISN is processed using an array of Kalman filters to capture a topological structure of the network and spatial features representing changes in the characteristics of the network.

In at least some embodiments, an optimal number of RPI instances required for operation in the network is adjusted based on a pre-determined threshold and at least one of the changes in the characteristics of the network.

An edge-based network includes at least one centralized hub and multiple edge-based network devices and gateways. In application scenarios where edge-based network devices send messages to a centralized hub for further processing, the messages are encrypted using public-private cryptography to ensure end-to-end security between the edge-based network devices and the centralized hub. Encryption is especially necessary where communication links between edge sites are based on standard messaging protocols such as, but not limited to, Message Queuing Telemetry Transport (MQTT). As a centralized hub mostly resides in a trusted network, it is important to inspect some aspects of a message before the message is delivered to the centralized hub. However, the message can only be decrypted by the centralized hub, and any attempt to decrypt the message before it is delivered to the centralized hub may void any trust in the message.

A certificate chain is a hierarchy of certificates in a network. The certificate chain includes either multiple Leaf Certificates that are generated for edge-based network devices of the network (i.e., one for each edge-based network device) or multiple Intermediate Certificates that are generated and in turn used to generate the multiple Leaf Certificates for the devices. The certificate chain further includes a Root Certificate held by a centralized hub of the network. The certificate chain terminates with the Root Certificate.

If an entity wants to verify a Leaf Certificate, the entity will verify the entire certificate chain (i.e., up to and including the Root Certificate). All entities involved in the end-to-end security—the edge-based network devices, the edge-based network gateways, and the centralized hub—have their own certificates that are part of the same certificate chains. Conventional solutions that involve certificate chains cannot inspect messages to be delivered to a centralized hub without compromising end-to-end security.

One or more embodiments of the invention provide RPI for encrypted traffic in an edge-based network. In some embodiments, at least one RPI instance is deployed in the network to inspect each message generated by each edge-based network device of the network before the message is delivered to a centralized hub of the network. Each RPI instance can inspect messages without any security key from the centralized hub. By removing the need for the centralized hub to share a security key with each RPI instance, end-to-end security between each edge-based network device and the centralized hub is maintained (i.e., not broken or compromised).

A large edge-based network may have multiple load-balanced centralized hubs to handle large numbers of edge-based network devices and gateways, such that adding another hop increases overall latency and complexity at the network. In some embodiments, an optimal number of RPI units/instances required for operation is determined with a technical network design constraint that a required amount of latency must be maintained (e.g., the amount of latency must not exceed a pre-determined threshold). In some embodiments, an optimal number of RPI units/instances required for operation (i.e., how many are needed and when) is based on a semantic model/graph of the network. In some embodiments, operational data/metadata relating to the edge-based network is monitored. The operational data/metadata is indicative of different characteristics/features of interest of the edge-based network. In some embodiments, anomaly detection in the edge-based network is performed.

Each RPI instance is a separate entity and does not fall under the purview of the edge-based network. Specifically, each RPI instance has its own certificate which is not part of a certificate chain that includes certificates (e.g., Root Certificate, Leaf Certificates) of the centralized hub and edge-based network devices and gateways. As such, in some embodiments, two different and separate certificate chains for end-to-end communication are utilized—one certificate chain including certificates for the RPI units/instances, and another certificate chain including certificates for the centralized hub and the edge-based network devices and gateways. This ensures end-to-end security between the edge-based network devices and the centralized hub is not compromised as the security of each message from its source to its destination is maintained. Each RPI instance is able to inspect edge-based network traffic without undermining an established security protocol and an established certificate chain that includes certificates for the centralized hub and the edge-based network devices and gateways. A RPI instance is able to securitize edge-based network traffic without carrying out processes like decrypting messages or certificate chaining. While an RPI instance can decrypt a message encrypted by an edge-based network gateway using its certificate, the RPI instance need not decrypt an original message encrypted by an edge-based network device, thereby ensuring that the original message remains intact. Each RPI instance inspects messages without breaking security of the messages (i.e., undermining the established certificate chain of the network). Therefore, in some embodiments, a wrapper on encrypted traffic data is provided within the edge-based network.

Identity Semantic Network (ISN) is a semantic description of a network, wherein the semantic description is based on characteristics/features of the network such as, but not limited to, its physical structure (e.g., number of layers and hops that a device takes to complete a transaction), its data and event processing structure, etc. In some embodiments, as part of monitoring and anomaly detection, a sensitivity level of an ISN of an edge-based network is determined based on one or more changes in one or more characteristics/features of the network. For example, if a change is significantly larger than a pre-determined threshold, an optimal number of RPI units/instances required for operation changes accordingly. In some embodiments, an ISN of an edge-based network is represented as a Fourier function. In some embodiments, an ISN of an edge-based network is processed using an array of Kalman filters to capture a topological structure of the network and spatial features between nodes representing changes in characteristics/features of the network.

In some embodiments, as part of monitoring and anomaly detection, residuals of prediction at each edge-based network device are monitored. In some embodiments, as part of monitoring and anomaly detection, representational errors that use estimation consistencies between ISN states and processed states are monitored.

A knowledge graph, also known as a semantic network, is a graph structure representing a network of real-world entities and illustrating relationships between them. For example, a knowledge graph of an edge-based network provides basic knowledge of a physical structure of the network and available data for the network. A semantic model/graph of an edge based network is an enriched knowledge graph of the network that represents semantic relationships between edge-based network devices of the network. A semantic model/graph of an edge-based network includes, for each edge-based network device of the network, a node representing the device.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

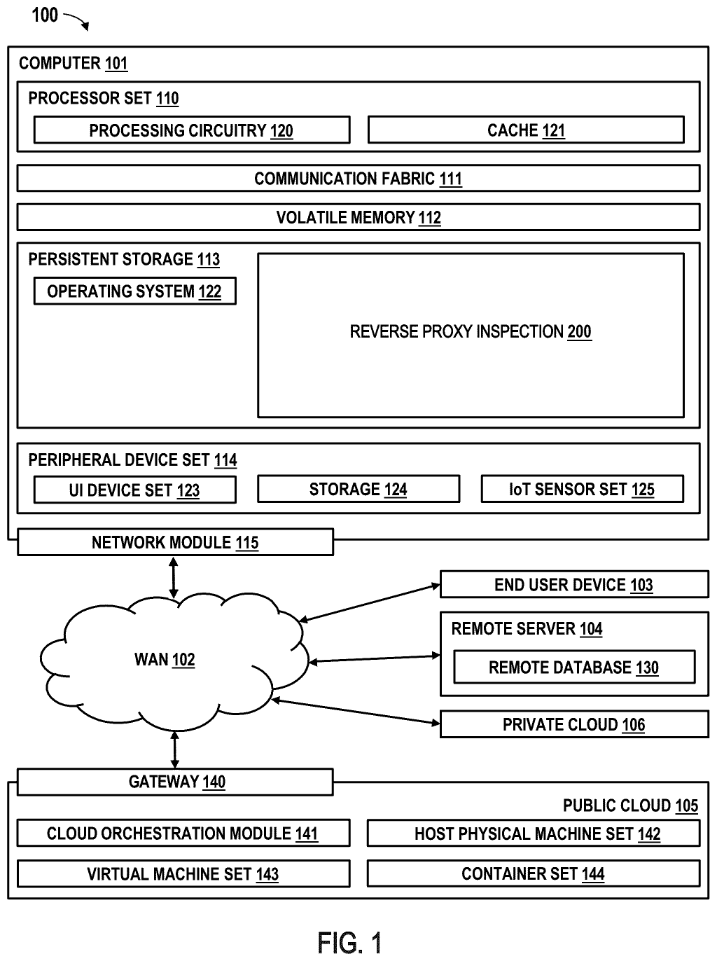

FIG. 1 depicts a computing environment 100 according to an embodiment of the present invention. Computing environment 100 contains an example of an environment for the execution of at least some of the computer code involved in performing the inventive methods, such as RPI code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and IoT sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

A trusted network is a network of devices that are connected to each other, open only to authorized users, and allows for only secure data to be transmitted.

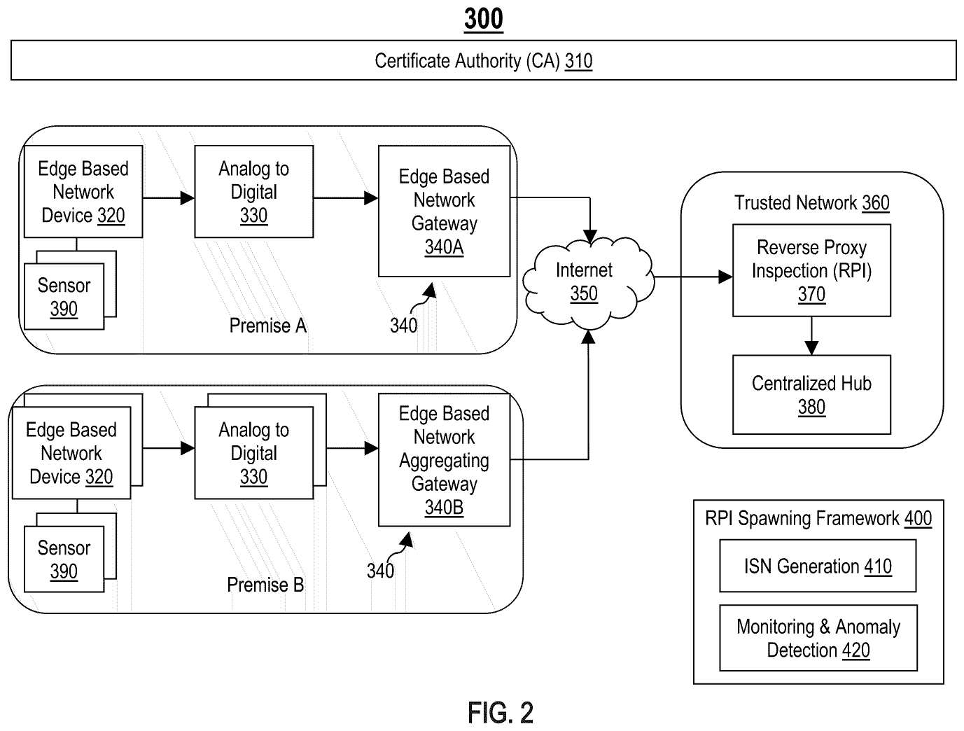

FIG. 2 illustrates an example edge-based network 300 implementing RPI, in accordance with an embodiment of the invention. In some embodiments, the edge-based network 300 comprises, but is not limited to, the following: (1) a CA 310, (2) one or more edge-based network devices 320, (3) one or more analog to digital units 330, (4) one or more edge-based network gateways 340, (5) one or more centralized hubs 380, (6) a RPI spawning framework 400, and (7) one or more RPI instances 370 spawned by the framework 400. Each RPI instance 370 and each centralized hub 380 is part of a trusted network 360.

Each edge-based network device 320, each analog to digital unit 330, and each edge-based network gateway 340 is installed on-premises. For example, if only one edge-based network device 320 is installed at a premise (e.g., Premise A), only one corresponding analog to digital unit 330 and only one corresponding edge-based network gateway 340A are installed at the same premise. As another example, if multiple edge-based network devices 320 are installed at a premise (e.g., Premise B), multiple corresponding analog to digital units 330 and one edge-based network aggregating gateway 340B are installed at the same premise.

For each edge-based network device 320, the CA 310 is configured to generate and issue to the device 320 a signed certificate corresponding to the device 320. For expository purposes, the term “Device-Certificate” as used herein generally refers to a signed certificate corresponding to an edge-based network device 320. Authenticity of a Device-Certificate issued by the CA 310 may be verified by the CA 310. Each edge-based network device 320 shares its corresponding Device-Certificate with a centralized hub 380. Each Device-Certificate is part of a certificate chain used for end-to-end communication between the one or more edge-based network devices 320 and the one or more centralized hubs 380.

For each RPI instance 370, the CA 310 is configured to generate and issue to the RPI instance 370 a signed certificate corresponding to the RPI instance 370. For expository purposes, the term “RPI-Certificate” as used herein generally refers to a signed certificate corresponding to a RPI instance 370. Authenticity of a RPI-Certificate issued by the CA 310 may be verified by the CA 310. Each RPI instance 370 shares its corresponding RPI-Certificate with an edge-based network gateway 340 (e.g., an edge-based network gateway 340A and/or an edge-based network aggregating gateway 340B). Each RPI-Certificate is part of a certificate chain used for end-to-end communication between the one or more edge-based network gateways 340 and the one or more RPI instances 370. Therefore, two different and separate certificate chains for end-to-end communication are utilized in the network 300—one certificate chain including RPI-Certificates, and another certificate chain including Device-Certificates.

Each edge-based network device 320 is configured to: (1) generate a message comprising telemetry data, (2) encrypt the message with an initial layer of encryption using a Device-Certificate corresponding to the device 320, and (3) provide, as output, the encrypted message for delivery to a centralized hub 380. Each edge-based network device 320 is integrated in or coupled to different IoT sensors 390 for capturing/recording measurements of different characteristics/features of the edge-based network 300.

If only one edge-based network device 320 is installed at a premise (e.g., Premise A), each encrypted message output from the device 320 for delivery to a centralized hub 380 is converted from an analog to digital via an analog to digital unit 330 installed at the same premise. Further, an edge-based network gateway 340A installed at the same premise receives the encrypted message from the analog to digital unit 330, encrypts or wraps the encrypted message with a subsequent layer of encryption using a RPI-Certificate corresponding to a RPI instance 370, and forwards the encrypted message to the RPI instance 370 via the Internet 350.

If multiple edge-based network devices 320 are installed at a premise (e.g., Premise B), each encrypted message output from each device 320 for delivery to a centralized hub 380 is converted from analog to digital via an analog to digital unit 330 installed at the same premise and corresponding to the device 320. An edge-based network aggregating gateway 340B installed at the same premise receives all encrypted messages from all analog to digital units 330 installed at the same premise, aggregates the encrypted messages, encrypts or wraps the resulting aggregated encrypted message with a subsequent layer of encryption using a RPI-Certificate corresponding to a RPI instance 370, and forwards the encrypted message with the wrapper to the RPI instance 370 via the Internet 350.

As shown in FIG. 2, each RPI instance 370 is connected to a centralized hub 380 via single connection, thereby removing the need for a plurality of connections (one for each of the edge-based network devices 320) and reducing attack surface. An attack surface is the entire area of a system that is susceptible to hacking.

Each RPI instance 370 is configured to: (1) receive an encrypted message that has been encrypted or wrapped with a subsequent layer of encryption using a RPI-Certificate (e.g., by an edge-based network gateway 340A or an edge-based network aggregating gateway 340B), (2) authenticate the RPI-Certificate, (3) decrypt the subsequent layer of encryption using the RPI-Certificate, resulting in the encrypted message with an initial layer of encryption intact (i.e., the encrypted message remains encrypted using a Device-Certificate), (4) inspect the encrypted message, and (5) forward the encrypted message to a centralized hub 380. By decrypting only the subsequent layer of encryption and not the initial layer of encryption, the RPI instance 370 can inspect an encrypted message without compromising the certificate chain that includes Device-Certificates (and that is used for end-to-end communication between the one or more edge-based network devices 320 and the one or more centralized hubs 380).

Each centralized hub 380 is configured to: (1) receive an encrypted message with an initial encryption later intact (e.g., from a RPI instance 370), (2) decrypt the initial layer of encryption using a Device-Certificate corresponding to a device 320 that shared the Device-Certificate with the centralized hub 380, and (3) process the resulting decrypted message (e.g., process plain text of the decrypted message).

An edge-based network can be represented as a graph, wherein a topological structure of the network (or topology of the graph) is learned from operational data/metadata relating to the network. In some embodiments, the framework 400 comprises an ISN generation unit 410 configured to automatically generate and configure an RPI-based ISN of the edge-based network 300 based on a knowledge graph that represents a physical structure (e.g., number of layers and hops that an edge-based network device 320 takes to complete a transaction) of the network 300 and a data model representing a data and event processing structure of the network 300. The ISN represents causal knowledge comprising causal relationships between edge-based network devices 320 of the network 300.

In some embodiments, the framework 400 comprises a monitoring and anomaly detection unit 420 configured to: (1) monitor operational data/metadata relating to the edge-based network 300, and (2) detect one or more anomalies (i.e., anomaly detection) in the network 300. As described in detail later herein, in some embodiments, operational data/metadata relating to the network 300 is captured/recorded utilizing different IoT sensors 390 integrated in or coupled to each edge-based network device 320. The operational data/metadata is indicative of characteristics/features of interest of the network 300.

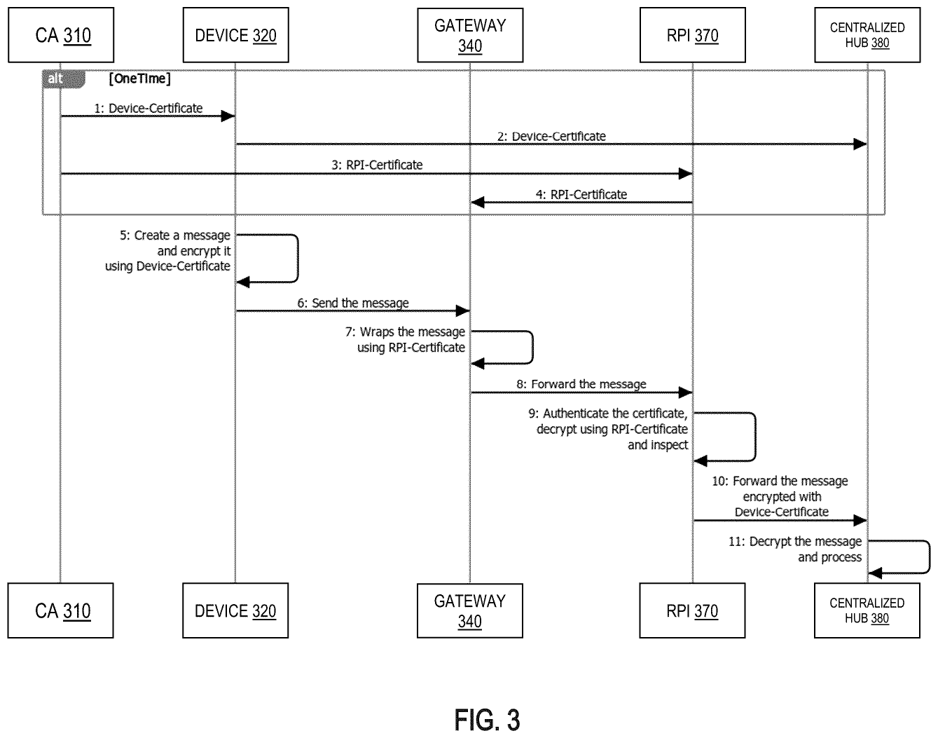

FIG. 3 illustrates an example workflow for implementing RPI in the edge-based network 300, in accordance with an embodiment of the invention. First, the CA 310 generates and issues to an edge-based network device 320 of the network 300 a corresponding Device-Certificate. Second, the edge-based network device 320 shares the Device-Certificate with a centralized hub 380 of the network 300. Third, the CA 310 generates and issues to a RPI instance 370 deployed in the network 300 a corresponding RPI-Certificate. Fourth, the RPI instance 370 shares the RPI-Certificate with an edge-based network gateway 340 (e.g., edge-based network gateway 340A and/or an edge-based network aggregating gateway 340B) of the network 300.

Fifth, the edge-based network device 320 generates a message and encrypts the message with an initial layer of encryption using the Device-Certificate. Sixth, the resulting encrypted message is sent to the edge-based network gateway 340. Seventh, the edge-based network gateway 340 encrypts or wraps the encrypted message with a subsequent layer of encryption using the RPI-Certificate. Eighth, the edge-based network gateway 340 forwards the encrypted message to the RPI instance 370.

Ninth, the RPI instance 370 authenticates the RPI-Certificate, decrypts the subsequent layer of encryption using the RPI-Certificate, and inspects the encrypted message with the initial layer of encryption intact. Tenth, the RPI instance 370 forwards the encrypted message to the centralized hub 380. Eleventh, the centralized hub 380 decrypts the encrypted message using the Device-Certificate, and processes the resulting decrypted message (e.g., processes plain text of the decrypted message).

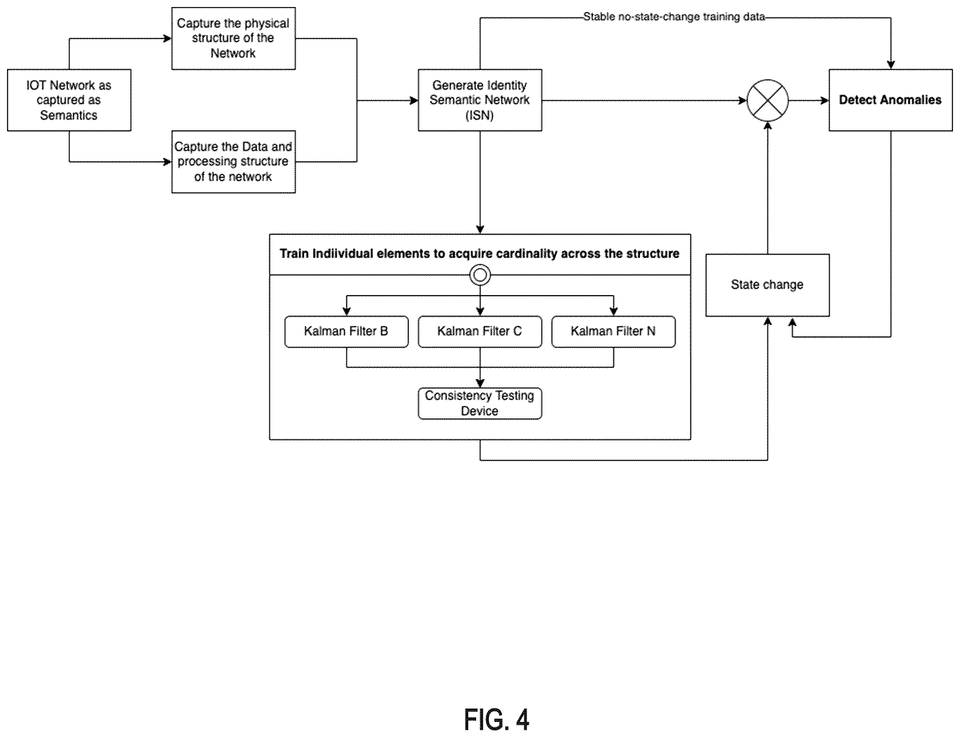

FIG. 4 illustrates an example workflow implemented by the RPI spawning framework 400, in accordance with an embodiment of the invention. The ISN generation unit 410 generates an ISN of the edge-based network 300 by: (1) deriving a semantic model/graph of the network 300 from operational data/metadata relating to the network 300, (2) extracting an adjacency matrix for edge-based network devices 320 of the network 300 using the semantic model/graph, (3) generating the ISN based on the semantic model/graph, and (4) training the ISN using stable no-state-change training data. Stable no-state-change training data is training data obtained under stable conditions in which no state changes (i.e., changes in characteristics/features of the network 300) are detected.

The ISN is trained to learn causal relationships between the edge-based network devices 320 (i.e., train individual elements to acquire cardinality across the structure of the network 300). The causal relationships are characterized by operational data/metadata relating to the network 300. The operational data/metadata include measurements of characteristics/features in the network 300 that are captured/recorded by IoT sensors 390 integrated in or coupled to the edge-based network devices 320. The operational data/metadata captures a semantic description of the network 300, including its physical structure and its data and event processing structure.

A semantic model/graph of an edge-based network is described by a plurality of characteristics/features of the network. For example, in some embodiments, a semantic model/graph of an edge-based network is represented in accordance with equation (1) provided below:

$$RPI ( j ) ⋀ hasData ( j , m ) ⋀ Message ( m ) \qquad ( 1 )$$

$$RPI ( j ) ⋀ hasData ( j , f ) ⋀ Frequency ( f )$$

$$RPI ( j ) ⋀ hasData ( j , d ) ⋀ Device ( d )$$

$$RPI ( j ) ⋀ hasData ( j , h ) ⋀ Hops ( h )$$

$$⇒ influences ( m , f , d , h ) ,$$

wherein j is an integer value, RPI (j) is a j^{th} RPI instance, m, f, d, and h are characteristics/features, m is a message, f is a frequency, d is an edge-based network device, h is a number of hops, and influences (m, f, d, h) is an influences relationship between the characteristics m, f, d, and h.

In some embodiments, the ISN generation unit 410 is configured to identify a plurality of characteristics/features that describe a semantic model/graph of the edge-based network 300 using equation (1) provided above. For example, the ISN generation unit 410 automatically creates an influences relationship influences (m, f, d, h) between characteristics/features m, f, d, and h for all instances RPI (j) (i.e., RPI instances 370) that have associated characteristics m, f, d, and h assigned via a hasData relationship. The characteristics/features m, f, d, and h identified are influencing forces.

In some embodiments, the ISN generation unit 410 is configured to generate a graph of each characteristic of the plurality of characteristics/features identified. In some embodiments, the ISN generation unit 410 generates a graph of a given characteristic/feature from equation (1) by running a search query on the semantic model/graph to extract all nodes of the semantic model/graph that have the given characteristic/feature. Each node extracted from the semantic model/graph represents an edge-based network device 320 of the edge-based network 300 that has the given characteristic/feature. For example, in some embodiments, the ISN generation unit 410 runs a search query represented in accordance with equation (2) provided below:

$${S}_{d e v i c e} = Device ( d ) ⋀ {influences}_{x = 1}^{L} ( d , x ) ⋀ Data ( x ) , \qquad ( 2 )$$

wherein the search query returns for each device d all respective causal sources x. The search query also returns property chains of successive influences relationships up to a maximum depth L, wherein L is a given average number of hops (assuming a standard network model allows for an average of L hops).

In some embodiments, the ISN generation unit 410 generalizes the graph generated using equation (2) provided above, resulting in a generalized graph of all of the plurality of characteristics/features identified. Specifically, the ISN generation unit 410 extends the search query represented by equation (2) provided above for all of the plurality of characteristics/features identified. For example, in some embodiments, the search query represented by equation (2) provided above is extended for all given characteristics/features m, f, d, h from equation (1), in accordance with equation (3) provided below:

$${S}_{features} = \{ Feature ( i ) ⋀ {influences}_{x = 1}^{L} ( d , x ) ⋀ Data ( x ) , ∀ i ∈ Feature ( m , f , d , h ) \} , \qquad ( 3 )$$

wherein Feature (i) is a set of all characteristics/features that defines the structure of the edge-based network and influences the design of each instance of a RPI instance 370.

Equation (4) automatically transforms the result set of semantic functionality such as influences (m, f, d, h) from equation (1) into the ISN. The ISN is a sub-graph of the semantic model/graph. In some embodiments, the ISN of the edge-based network 300 is represented as a Fourier function.

In some embodiments, a topological structure of an edge-based network and spatial features between nodes that represent changes in characteristics/features of the network are represented in accordance with equation (4) provided below:

$${[ f ( X , A ) = {σ ( \hat{A} ReLU ( \hat{A} X , {W}^{( 0 )} ) {W}^{( 1 )} )}_{\hat{A} = {\hat{D}}^{- \frac{1}{2}} \hat{A} {\hat{D}}^{- \frac{1}{2}}} ]}_{≡ \partial ( L = 2 )} , \qquad ( 4 )$$

wherein X is a feature matrix at the level of the nodes, A is an adjacency matrix for edge-based network devices of the network, A=A+I_{N}, I_{N} is an identity matrix that considers the characteristics/features of the nodes for which the learning is conducted, \hat{D} is a degree matrix containing information on a number of connection per node, \hat{D}=ΣⱼAᵢⱼ, W⁽⁰⁾ and W⁽¹⁾ are weight matrices for first-order neighborhood and second-order neighborhood of the nodes, and σ and ReLU are activation functions. Equation (4) represents the structure of the edge-based network and its allied dataflow as characteristics/features of the network, and the available endpoint as the filter.

In some embodiments, the monitoring and anomaly detection unit 420 is configured to detect one or more anomalies (i.e., anomaly detection) in the edge-based network 300 using an array of Kalman filters (i.e., σ in equation (4) provided above is the array of Kalman filters). Specifically, the monitoring and anomaly detection unit 420 processes the ISN of the network 300 using the array of Kalman filters (e.g., Kalman Filter B, Kalman Filter C, Kalman Filter N). The array of Kalman filters act on nodes of the semantic model/graph and its first-order neighborhood (i.e., closest neighbors of the nodes) to capture a topological structure of the network 300 and spatial features between nodes representing changes in characteristics/features of the network 300. Therefore, the monitoring and anomaly detection unit 420 can detect a change in a subset of measurements of characteristics/features of the network 300, wherein the measurements are captured/recorded by the IoT sensors 390.

In some embodiments, the array of Kalman filters comprises a main filter and one or more representative filters. In some embodiments, the monitoring and anomaly detection unit 420 monitors, via a consistency testing device, estimation consistencies between the main filter and the one or more representative filters (i.e., estimation consistencies between ISN states and processed states). If there is no failure (i.e., there is no anomaly in the edge-based network 300), a statistical property indicative of estimation differences between the main filter and the one or more representative filters is represented in accordance with equations (5)-(6) provided below:

$${\partial }^{i} ( k \vert k ) {=}^{△} \partial ( k ) - {\partial }^{i} ( k \vert k ) , and \qquad ( 5 )$$

$${P}^{i} ( k \vert k ) {=}^{△} E \{ {\partial }^{i} {( k \vert k ) [ {\partial }^{i} ( k \vert k ) ]}^{T} \} , \qquad ( 6 )$$

wherein E is an expected value, P is a probability, and P=E{A.A^{T}}. For example, if i∈[A,N] and j∈[B,N], estimation differences between the main filter and the one or more representative filters is represented in accordance with equation (7.1) provided below:

$${P}^{i} ( k \vert k ) {=}^{△} \partial ( k ) - {\partial }^{i} ( k \vert k ) \qquad ( 7.1 )$$

wherein equation (7.1) can be rewritten in terms of the one or more representative filters, as represented in accordance with equation (7.2) provided below:

$${\{ {P}^{i} ( k \vert k ) {=}^{△} {\partial }^{A} ( k ) - {\partial }^{j} ( k \vert k ) \}}_{{j = B … N}_{i = A , j}} , \qquad ( 7.2 )$$

In some embodiments, a representational error ξ is represented in accordance with equation (8) provided below:

$$E [ {P}^{i} ( k ) ] {=}^{△} E [ {\partial }^{A} ( k \vert k ) ] - E [ {\partial }^{j} ( k \vert k ) ] = {e}^{ξ} , \qquad ( 8 )$$

wherein the representational error ξ is exponential for large values of change in characteristics/features of the network.

When there is no failure, all state estimates (i.e., predictions) from all filters of the array of Kalman filters are unbiased, and the monitoring and anomaly detection unit 420 does not detect an anomaly in the edge-based network 300. If there is a failure, the monitoring and anomaly detection unit 420 detects an anomaly in the network 300. In some embodiments, the monitoring and anomaly detection unit 420 determines a representational error ξ using equation (8) provided above, and detects a structural change in the network 300 if e^{ξ}>>0. If a structural change in the network 300 is detected, the monitoring and anomaly detection unit 420 infers the structural change as an anomaly in the network 300.

In some embodiments, the ISN of the network 300 has a technical network design constraint in which a required amount of latency must be maintained. For example, in some embodiments, the amount of latency allowed is based on pre-determined threshold φ_{threshold}. In some embodiments, the monitoring and anomaly detection unit 420 is configured to determine an optimal number of RPI instances 370 required for operation with the constraint on the amount of latency.

For a given space of the pre-determined threshold φ_{threshold}, a functional binding or mapping with the representational error ξ in the form of e^{ξ} is required. By training the representational error ξ for a varied range of space of the pre-determined threshold φ_{threshold}, the ISN allows a functional binding or mapping represented in accordance with equation (9) provided below:

$${φ}_{threshold} = {λ}_{Spawning - index} \times {e}^{{ξ}_{representational}} , \qquad ( 9 )$$

wherein λ_{Spawning-index} is a spawning index for RPI instances 370.

In some embodiments, the monitoring and anomaly detection unit 420 determines the spawning index λ_{Spawning-index} for RPI instances 370 in a real-time, or near real-time, setting in accordance with equation (10) provided below:

$${λ}_{Spawning - index} = \frac{{φ}_{t h r e s h o l d}}{{e}^{{ξ}_{r e p r e s e n t a t i o n a l}}} . \qquad ( 10 )$$

The monitoring and anomaly detection unit 420 spawns an optimal number of RPI instances 370 in accordance with the spawning index λ_{spawning-index}. The RPI instances 370 are then trained using stable no-state-change training data and deployed in the network 300.

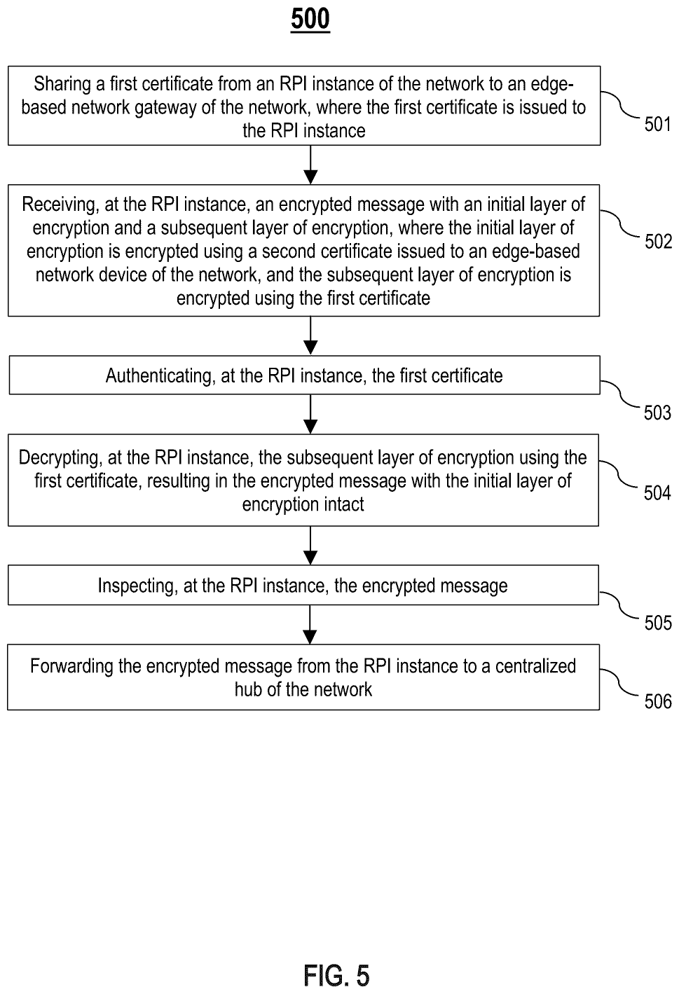

FIG. 5 is a flowchart for an example process 500 for RPI of encrypted traffic in an edge-based network, in accordance with an embodiment of the invention. Process block 501 includes sharing a first certificate from an RPI instance of the network to an edge-based network gateway of the network, where the first certificate is issued to the RPI instance. Process block 502 includes receiving, at the RPI instance, an encrypted message with an initial layer of encryption and a subsequent layer of encryption, where the initial layer of encryption is encrypted using a second certificate issued to an edge-based network device of the network, and the subsequent layer of encryption is encrypted using the first certificate. Process block 503 includes authenticating, at the RPI instance, the first certificate. Process block 504 includes decrypting, at the RPI instance, the subsequent layer of encryption using the first certificate, resulting in the encrypted message with the initial layer of encryption intact. Process block 505 includes inspecting, at the RPI instance, the encrypted message. Process block 506 includes forwarding the encrypted message from the RPI instance to a centralized hub of the network.

In some embodiments, process blocks 501-506 are performed by an RPI instance 370 and one or more components of the system 300.

From the above description, it can be seen that embodiments of the invention provide a system, computer program product, and method for implementing the embodiments of the invention. Embodiments of the invention further provide a non-transitory computer-useable storage medium for implementing the embodiments of the invention. The non-transitory computer-useable storage medium has a computer-readable program, wherein the program upon being processed on a computer causes the computer to implement the steps of embodiments of the invention described herein. References in the claims to an element in the singular is not intended to mean “one and only” unless explicitly so stated, but rather “one or more.” All structural and functional equivalents to the elements of the above-described exemplary embodiment that are currently known or later come to be known to those of ordinary skill in the art are intended to be encompassed by the present claims. No claim element herein is to be construed under the provisions of 35 U.S.C. § 112 (f), unless the element is expressly recited using the phrase “means for” or “step for.”

The terminology used herein is for the purpose of describing particular embodiments of the invention only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed.

The descriptions of the various embodiments of the invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for reverse proxy inspection (RPI) of encrypted traffic in an edge-based network, comprising:
sharing a first certificate from an RPI instance of the network to an edge-based network gateway of the network, wherein the first certificate is issued to the RPI instance;
receiving, at the RPI instance, an encrypted message with an initial layer of encryption and a subsequent layer of encryption, wherein the initial layer of encryption is encrypted using a second certificate issued to an edge-based network device of the network, and the subsequent layer of encryption is encrypted using the first certificate;
authenticating, at the RPI instance, the first certificate;
decrypting, at the RPI instance, the subsequent layer of encryption using the first certificate, resulting in the encrypted message with the initial layer of encryption intact;
inspecting, at the RPI instance, the encrypted message; and
forwarding the encrypted message from the RPI instance to a centralized hub of the network.

2. The computer-implemented method of claim 1, wherein the first certificate and the second certificate are different signed certificates issued by a Certificate Authority (CA).

3. The computer-implemented method of claim 1, wherein the first certificate is part of a first certificate chain used for end-to-end communication between the edge-based network gateway and the RPI instance, and the second certificate is part of a second certificate chain that is different from the first certificate chain and used for end-to-end communication between the edge-based network device and the centralized hub.

4. The computer-implemented method of claim 1, wherein the initial layer of encryption is encrypted at the edge-based network device, and the subsequent layer of encryption is encrypted at the edge-based network gateway.

5. The computer-implemented method of claim 1, further comprising:
monitoring operational data relating to the network, wherein the operational data comprises measurements of characteristics of the network, and the operational data is captured via Internet of Things (IoT) sensors coupled to or integrated in edge-based network devices of the network.

6. The computer-implemented method of claim 5, further comprising:
deriving a semantic graph of the network from the operational data, wherein the semantic graph is a knowledge graph representing a physical structure of the network and a data and event processing structure of the network;
generating an identity semantic network (ISN) based on the semantic graph, wherein the ISN represents causal relationships between the edge-based network devices; and
processing the ISN using an array of Kalman filters to capture a topological structure of the network and spatial features representing changes in the characteristics of the network.

7. The computer-implemented method of claim 6, further comprising:
adjusting an optimal number of RPI instances required for operation in the network based on a pre-determined threshold and at least one of the changes in the characteristics of the network.

8. A system for reverse proxy inspection (RPI) of encrypted traffic in an edge-based network, comprising:
at least one processor; and
a non-transitory processor-readable memory device storing instructions that when executed by the at least one processor causes the at least one processor to perform operations including:
sharing a first certificate from an RPI instance of the network to an edge-based network gateway of the network, wherein the first certificate is issued to the RPI instance;
receiving, at the RPI instance, an encrypted message with an initial layer of encryption and a subsequent layer of encryption, wherein the initial layer of encryption is encrypted using a second certificate issued to an edge-based network device of the network, and the subsequent layer of encryption is encrypted using the first certificate;
authenticating, at the RPI instance, the first certificate;
decrypting, at the RPI instance, the subsequent layer of encryption using the first certificate, resulting in the encrypted message with the initial layer of encryption intact;
inspecting, at the RPI instance, the encrypted message; and
forwarding the encrypted message from the RPI instance to a centralized hub of the network.

9. The system of claim 8, wherein the first certificate and the second certificate are different signed certificates issued by a Certificate Authority (CA).

10. The system of claim 8, wherein the first certificate is part of a first certificate chain used for end-to-end communication between the edge-based network gateway and the RPI instance, and the second certificate is part of a second certificate chain that is different from the first certificate chain and used for end-to-end communication between the edge-based network device and the centralized hub.

11. The system of claim 8, wherein the initial layer of encryption is encrypted at the edge-based network device, and the subsequent layer of encryption is encrypted at the edge-based network gateway.

12. The system of claim 8, wherein the operations further include:
monitoring operational data relating to the network, wherein the operational data comprises measurements of characteristics of the network, and the operational data is captured via Internet of Things (IoT) sensors coupled to or integrated in edge-based network devices of the network.

13. The system of claim 12, wherein the operations further include:
deriving a semantic graph of the network from the operational data, wherein the semantic graph is a knowledge graph representing a physical structure of the network and a data and event processing structure of the network;
generating an identity semantic network (ISN) based on the semantic graph, wherein the ISN represents causal relationships between the edge-based network devices; and
processing the ISN using an array of Kalman filters to capture a topological structure of the network and spatial features representing changes in the characteristics of the network.

14. The system of claim 13, wherein the operations further include:
adjusting an optimal number of RPI instances required for operation in the network based on a pre-determined threshold and at least one of the changes in the characteristics of the network.

15. A computer program product for reverse proxy inspection (RPI) of encrypted traffic in an edge-based network, the computer program product comprising a computer readable storage medium having program instructions embodied therewith, the program instructions executable by a processor to cause the processor to:
share a first certificate from an RPI instance of the network to an edge-based network gateway of the network, wherein the first certificate is issued to the RPI instance;
receive, at the RPI instance, an encrypted message with an initial layer of encryption and a subsequent layer of encryption, wherein the initial layer of encryption is encrypted using a second certificate issued to an edge-based network device of the network, and the subsequent layer of encryption is encrypted using the first certificate;
authenticate, at the RPI instance, the first certificate;
decrypt, at the RPI instance, the subsequent layer of encryption using the first certificate, resulting in the encrypted message with the initial layer of encryption intact;
inspect, at the RPI instance, the encrypted message; and
forward the encrypted message from the RPI instance to a centralized hub of the network.

16. The computer program product of claim 15, wherein the first certificate and the second certificate are different signed certificates issued by a Certificate Authority (CA).

17. The computer program product of claim 15, wherein the first certificate is part of a first certificate chain used for end-to-end communication between the edge-based network gateway and the RPI instance, and the second certificate is part of a second certificate chain that is different from the first certificate chain and used for end-to-end communication between the edge-based network device and the centralized hub.

18. The computer program product of claim 15, wherein the initial layer of encryption is encrypted at the edge-based network device, and the subsequent layer of encryption is encrypted at the edge-based network gateway.

19. The computer program product of claim 15, wherein the program instructions executable by the processor further cause the processor to:
monitor operational data relating to the network, wherein the operational data comprises measurements of characteristics of the network, and the operational data is captured via Internet of Things (IoT) sensors coupled to or integrated in edge-based network devices of the network.

20. The computer program product of claim 19, wherein the program instructions executable by the processor further cause the processor to:
derive a semantic graph of the network from the operational data, wherein the semantic graph is a knowledge graph representing a physical structure of the network and a data and event processing structure of the network;
generate an identity semantic network (ISN) based on the semantic graph, wherein the ISN represents causal relationships between the edge-based network devices;
process the ISN using an array of Kalman filters to capture a topological structure of the network and spatial features representing changes in the characteristics of the network; and
adjust an optimal number of RPI instances required for operation in the network based on a pre-determined threshold and at least one of the changes in the characteristics of the network.
